(19) United States
(12) Patent Application Publication
(10) Pub. No.: US 2006/0009985 A1
(43) Pub. Date: Jan. 12, 2006

(54) Multi-channel audio system

(75) Inventors: Jung-wan Ko, Suwon-si (KR); Pan-gie Park, Yongin-si (KR); Sung-wook Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/151,548

(22) Filed: Jun. 14, 2005

(30) Foreign Application Priority Data
Jun. 16, 2004 (KR) 2004-44690
Jun. 25, 2004 (KR) 2004-48042

(51) Int. Cl. G10L 21/00

(52) U.S. Cl. 704/500

(57) ABSTRACT

A multi-channel audio system using a wireless transmission network used in a home theater includes: a master decoding an input multi-channel audio stream, outputting the decoded multi-channel audio stream, extracting a predetermined audio stream supported by a slave from the input multi-channel audio stream, and transmitting the extracted audio stream by wireless; and the slave transmitting information on an audio stream supported by the slave among a multi-channel audio stream to the master, receiving the extracted audio stream by wireless, decoding the received audio stream, and outputting the decoded audio stream. Accordingly, by extracting only data necessary to a slave and transmitting the data, a multi-channel audio system using a wireless network in which data is transmitted by saving a data bandwidth in a wireless communication environment in which a bandwidth of transmitted/received data is limited.

### CROSS-REFERENCE TO RELATED PATENT APPLICATIONS

This application claims the benefit of Korean Patent Application No. 2004-0044690, filed on Jun. 16, 2004 in the Korean Intellectual Property Office, and Korean Patent Application No. 2004-0048042, filed on Jun. 25, 2004 in the Korean Intellectual Property Office, the disclosures of which are incorporated herein in their entirety by reference.

### BACKGROUND OF THE INVENTION

1. Field of the Invention

An aspect of the present invention relates to a home theater, and more particularly, to a multi-channel audio system using a wireless transmission network forming a home theater.

2. Description of the Related Art

Recently, accompanying development of various kinds of image devices and audio systems, home theaters producing an effect as in a theater at home are widely used. A home theater is a home theater system including an image device, such as a projector, a projection, a plasma display panel (PDP), or a digital television, an audio visual (AV) receiver/amplifier supporting a digital theater system (DTS) with 5.1 channels or more or Dolby digital, and a speaker system with 5.1 channels or more, and a digital versatile disc (DVD) player. A user can enjoy at home clear images as in a theater through the image device forming the home theater and a magnificent audio sound that can be felt in a theater through the AV receiver/amplifier and the speaker system.

The home theater can be widely divided into an image portion and a sound portion. The image portion includes an image device, generally. The sound portion can include a multi-channel audio system. The multi-channel audio system includes an AV receiver/amplifier decoding a multi-channel audio stream and a speaker system receiving the decoded multi-channel audio stream and outputting a sound. The AV receiver/amplifier is a device decoding an input audio stream, amplifying the decoded audio stream, and outputting the amplified audio stream to the speaker system outputting a sound that people can hear. The speaker system includes a center speaker, a main speaker (or front speaker), a rear speaker (or surround speaker), and a sub-woofer speaker. For example, for a basic 5.1-channel such as that shown in FIG. 1A, the speaker system includes the center speaker 100 for 1 channel, the main (front) speakers 110 for 2 channels, the rear (surround) speakers 120 for 2 channels, and the sub-woofer speaker 130 for a 0.1 channel. Lately, the speaker system has been developed with a 6.1-channel or a 7.1-channel.

FIGS. 1A and 1 B are examples of a basic 5.1-channel home theater and a basic 6.1-channel home theater. FIG. 1A shows a home theater system with 5.1 channels, and FIG. 1 B shows a home theater system with 6.1 channels. As shown in FIG. 1 B, the 6.1 system includes an additional rear center speaker 140. For both home theater systems, there is a video system including a display 150 and audio systems. The audio system forming these home theaters will now be described in detail.

FIG. 2 is a block diagram of a conventional audio system forming a home theater. Referring to FIG. 2, an audio system of a home theater installed in a typical home is illustrated. To enjoy an audio sound with the feeling of presence, a home theater environment is constructed using 6 or 8 speakers as described above. In particular, to simplify lines connected to the speakers, a wireless transmission network can be used as shown in FIG. 2.

The audio system for a home theater includes a source unit 200, a master 210, a slave 220, a plurality of front speakers 212, and a plurality of rear speakers 222. The source unit 200 is a device supplying a multi-channel audio stream to the master 210, and a DVD player or a digital TV receiver corresponds to the source unit 200. The master 210 is a device having the following three functions of: 1) receiving the multi-channel audio stream from the source unit 200 and decoding the input multi-channel audio stream; 2) outputting the decoded multi-channel audio stream to the front speakers 212; and 3) transmitting the multi-channel audio stream to the slave 220, to which the rear speakers 222 are connected, through the wireless transmission network. The master 210 is directly connected to a left main speaker, a center speaker, a sub-woofer speaker, and a right main speaker, which are the front speakers 212 deployed at a near place, by wire and connected to the rear speakers 222 by wireless.

The slave 220 is a device having the following two functions of: 1) receiving the multi-channel audio stream from. the master 210 through the wireless transmission network decoding the received multi-channel audio stream; and 2) outputting the decoded multi-channel audio stream to the rear speakers 222. The slave 220 is directly connected to the rear speakers 222, which are deployed at a near place, by wire and connected to the front speakers 212 through the master 210 by wireless.

The front speakers 212 include the left main speaker, the center speaker, the sub-woofer speaker, and the right main speaker, and the rear speakers 222 include a left rear speaker and a right rear speaker. Speakers can be further connected according to performance of a home theater. In FIG. 2, an example in which a multi-channel speaker system including 6 speakers to support 5.1 channels is constructed is illustrated. As described above, the conventional audio system providing the home theater function includes the master 210, the slave 220, and 6 to 8 speakers.

FIG. 3 is a detailed block diagram of the master 210 included in the audio system shown in FIG. 2. Referring to FIGS. 3 and 2, the master 210 includes an audio decoder 310, an audio output module 320, and a wireless transmitter 330. The audio decoder 310 receives the multi-channel audio stream from the source unit 200 and decodes the received multi-channel audio stream. The audio output module 320 outputs the decoded multi-channel audio stream to the plurality of front speakers 212. The wireless transmitter 330 transmits the multi-channel audio stream received from the source unit 200 to the slave 220.

FIG. 4 is detailed block diagram of the slave 220 included in the audio system shown in FIG. 2. Referring to FIGS. 4 and 2, the slave 220 includes a wireless receiver 410, an audio decoder 420, and an audio output module 430. The wireless receiver 410 receives the multi-channel audio stream from the wireless transmitter 330 included in the master 210 by wireless and transmits the received multi-channel audio stream to the audio decoder 420. The audio decoder 420 decodes the received multi-channel audio stream and transmits the decoded multi-channel audio stream to the audio output module 430. The audio output module 430 outputs the decoded multi-channel audio stream to the plurality of rear speakers 222.

However, in the wireless environment in which data is transmitted/received in a wireless way, a bandwidth of the transmitted/received data is limited within a certain range. Thus, though it generally does not matter when only audio is,used, when wireless devices such as video, computer communication, and portable communication devices are simultaneously used at home, data transmitted/received in a wireless way may exceeds a designated bandwidth. In particular, since there is an increasing tendency for home automation by which various devices at home are integrated in a wireless way, the bandwidth limitation in a wireless environment is an important issue.

### SUMMARY OF THE INVENTION

An aspect of the present invention provides a multi-channel audio system using a wireless communication network in which data is transmitted by saving a data bandwidth in a wireless communication environment in which a bandwidth of transmitted/received data is limited.

According to an aspect of the present invention, there is provided a multi-channel audio system comprising: a master decoding an input multi-channel audio stream, outputting the decoded multi-channel audio stream, extracting a predetermined audio stream supported by a slave from the input multi-channel audio stream, and transmitting the extracted audio stream wirelessly; and the slave transmitting information on an audio stream supported by the slave among a multi-channel audio stream to the master, receiving the extracted audio stream by wireless, decoding the received audio stream, and outputting the decoded audio stream.

According to an aspect of the present invention, the master comprises: an audio decoder decoding the input multi-channel audio stream; an audio output module outputting the decoded multi-channel audio stream; a stream parser extracting the predetermined audio stream supported by the slave by parsing the input multi-channel audio stream; and a wireless transmitter transmitting the extracted audio stream wirelessly, receiving the information on the audio stream supported by the slave using a message according to a predetermined protocol, and controlling the stream parser to extract a relevant audio stream from the input multi-channel audio stream.

According to an aspect of the present invention, the slave comprises: a wireless receiver transmitting the information on the audio stream supported by the slave to the master using a message according to a predetermined protocol and receiving the audio stream supported in a wireless way from the master; an audio decoder decoding the received audio stream; and an audio output module outputting the decoded audio stream.

According to an aspect of the present invention, the message according to the predetermined protocol includes at least one of information indicating decoding capability of the slave, information on external devices used by the slave, and information on channels supported by the slave.

According to an aspect of the present invention, the information indicating decoding capability of the slave indicates an encoding scheme using a DTS 5.1 channel and/or an AC-3 7.1 channel that can be decoded by the slave.

According to an aspect of the present invention, the information on external devices used by the slave indicates the number of external devices, such as speakers, connected to the slave.

According to an aspect of the present invention, the information on channels supported by the slave indicates data on a left rear speaker channel or a right rear speaker channel that are received by and output from the slave.

According to an aspect of the present invention, the stream parser extracts only a core data portion except an extended data portion among the input multi-channel audio stream.

According to an aspect of the present invention, the stream parser extracts only data corresponding to channels supported by the slave among the core data portion.

According to another aspect of the present invention, there is provided a home theater system comprising the multi-channel audio system described above and an image device.

### BRIEF DESCRIPTION OF THE DRAWINGS

The above and other features and/or advantages of the present invention will become more apparent and more readily appreciated by describing in detail exemplary embodiments thereof with reference to the accompanying drawings in which:

FIGS. 1A and 1 B are examples of a basic 5.1-channel home theater and a basic 6.1-channel home theater;

FIG. 2 is a block diagram of a conventional audio system used in a home theater;

FIG. 3 is a detailed block diagram of a master included in the audio system shown in FIG. 2;

FIG. 4 is a detailed block diagram of a slave included in the audio system shown in FIG. 2;

FIG. 5A is a conceptual diagram of a conventional audio stream;

FIG. 5B is a conceptual diagram of an audio stream according to an embodiment of the present invention;

FIG. 6 is a block diagram of ari audio system according to an embodiment of the present invention;

FIG. 7 is a detailed block diagram of a master included in the audio system shown in FIG. 6;

FIG. 8 is a detailed block diagram of a slave included in the audio system shown in FIG. 6;

FIG. 9 is a diagram of a message based on a protocol according to an embodiment of the present invention; and

FIG. 10 is a block diagram of an audio system according to another embodiment of the present invention.

### DETAILED DESCRIPTION OF THE EMBODIMENTS

Embodiments of the present invention will now be described in detail with reference to the accompanying drawings, wherein like reference numerals refer to the like elements throughout. The embodiments are described below in order to explain the present invention by referring to the figures.

Formats of an encoded multi-channel audio stream, which are conceptually represented, will now be described. FIG. 5A is a conceptual diagram of a conventional audio stream. Referring to FIG. 5A, a multi-channel audio stream encoded according to a conventional audio data encoding method is shown as core data 510. That is, audio stream data according to the conventional encoding method such as DTS or Dolby Digital AC-3 supporting multi-channel audio is represented with the core data 510. According to an applied encoding method, the core data 510 can have different or the same formats.

FIG. 5B is a conceptual diagram of an audio stream according to an embodiment of the present invention. Referring to FIG. 5B, a new encoding method obtained by improving the conventional encoding method is a method of adding extended data 530 to core data 520 to have a backward compatibility with the conventional core data 520. The new encoding method is a method of realizing high resolution, increasing the number of supported channels, or realizing lossless encoding using the extended data 530 in addition to the conventional audio stream encoding method. According to an applied encoding method, the core data 510 and the extended data 530 can have a different format.

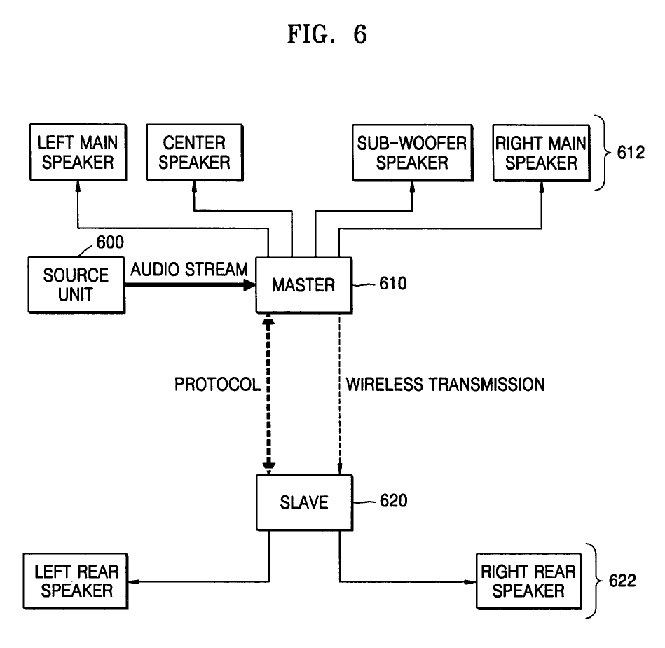

A configuration of an audio system to reproduce the multi-channel audio stream will now be described. FIG. 6 is a block diagram of an audio system according to an embodiment of the present invention. Referring to FIG. 6, a source unit 600 outputs a multi-channel audio stream. A master 610 of the audio system does not wirelessly transmit the entire input multi-channel audio stream received from the source unit 600 to a slave 620. Instead, the master 610 transmits only data that is necessary to the slave 620 by determining those portions of the input audio stream data needed by the slave 620. For example, if the slave 620 cannot process the extended data 530 according to the new encoding method illustrated in FIG. 5B, the master 610 transmits only core data to the slave 620. Alternately, if the slave 620 needs two-channel data, the master 610 transmits only the needed two-channel data to the slave 620 as opposed to more than two channels.

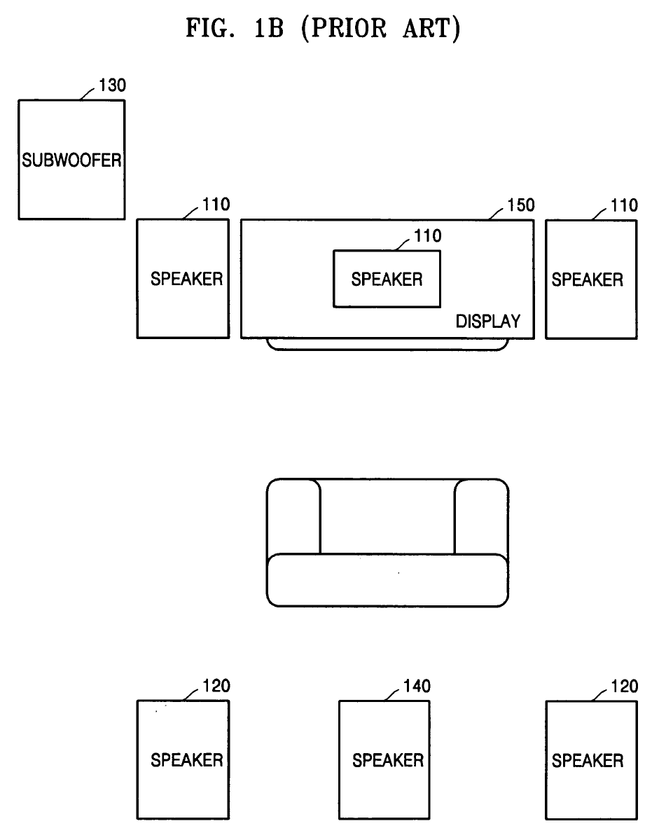

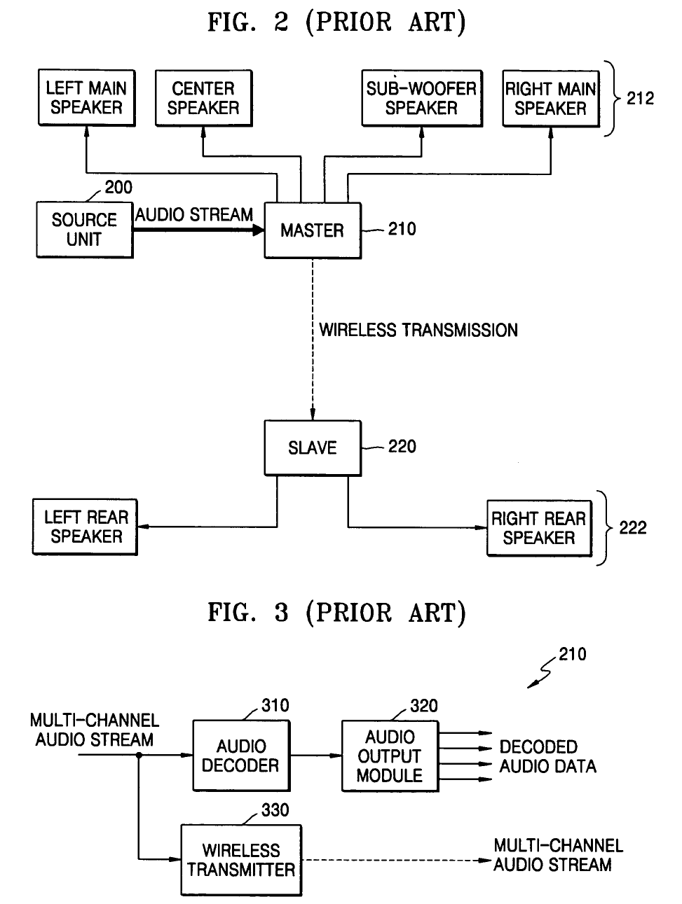

In more detail, the master 610 of the multi-channel audio system according to an embodiment of the invention determines an audio stream necessary to the slave 620 among a multi-channel audio stream input from a source unit 600. That is, while the master 210 of the conventional audio system transmits the entire multi-channel audio stream input form the source unit 200 to the slave 220 without a special process as illustrated in FIG. 2, the master 610 of the audio system according to the present embodiment extracts only an audio stream actually supported by the slave 620 among the multi-channel audio stream and transmits the extracted audio stream to the slave 620 by wireless.

Accordingly, since a bandwidth of data transmitted in a wireless way can be saved, a problem generated by data transmitted/received in a wireless way exceeding a designated bandwidth when wireless devices such as video, computer communication, and portable devices are simultaneously used at home can be solved. That is, by extracting only the audio stream of channels supported by the slave 620 and transmitting the extracted audio stream by wireless, a problem of the prior art in which a bandwidth of transmitted/received data is wasted by wirelessly transmitting an audio stream related to a left main speaker, a center speaker, a sub-woofer speaker, and a right main speaker, which are not used in the slave 620, can be solved. In addition, a problem of wasting a bandwidth of transmitted/received data by wirelessly transmitting the extended data, which is not supported, can also be solved.

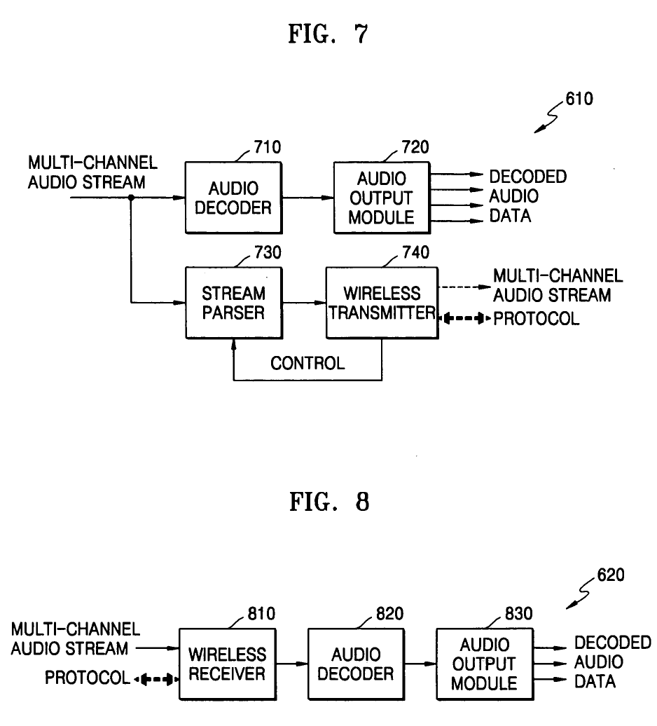

FIG. 7 is a detailed block diagram of the master 610 included in the audio system shown in FIG. 6. Referring to FIG. 7, the master 610 includes an audio decoder 710, an audio output module 720, a stream parser 730, and a wireless transmitter 740. The audio decoder 710 and the audio output module 720 are equal to those illustrated in FIG. 3.

The wireless transmitter 740 determines audio stream data necessary to the slave 620 according to a predetermined protocol between the wireless transmitter 740 of the master 620 and a wireless receiver of the slave 620 and controls the stream parser 730 to extract only the audio stream data necessary to the slave 620 from an input multi-channel audio stream. It is understood that in addition to using protocols to automatically detect the required audio streams, it is also possible to manually indicate to the master 610 the audio streams required.

The stream parser 730 receives information on the audio stream data necessary to the slave 620 from the wireless transmitter 740 and extracts only the audio stream data necessary to the slave 620 from the input multi-channel audio stream. The extracted audio stream data is transmitted to the wireless receiver of the slave 620 through the wireless transmitter 740.

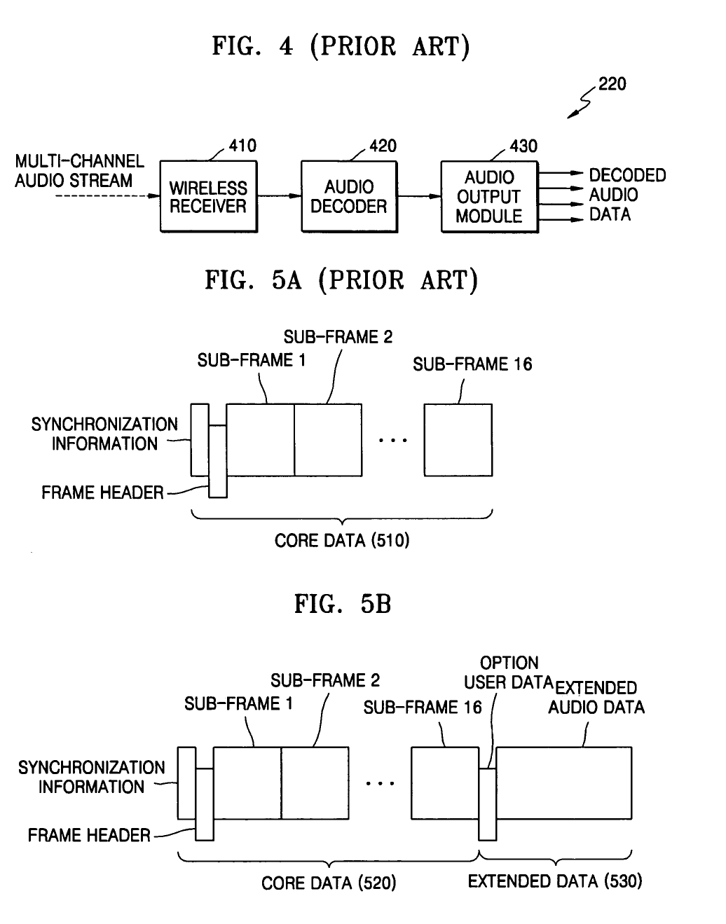

FIG. 8 is a detailed block diagram of the slave 620 included in the audio system shown in FIG. 6. Referring to FIG. 8, the slave 620 includes a wireless receiver 810, an audio decoder 820, and an audio output module 830. The audio decoder 820 and the audio output module 830 are otherwise similar to those illustrated in FIG. 4.

The wireless receiver 810 transmits information on audio stream data necessary to the slave 620 to the master 610 using the predetermined protocol. The wireless receiver 810 receives the audio stream data necessary to the slave 620 extracted from an input multi-channel audio stream from the master 610 and transmits the received audio stream data to the audio decoder 820. The transmitted audio stream is decoded and output to a plurality of rear speakers 622.

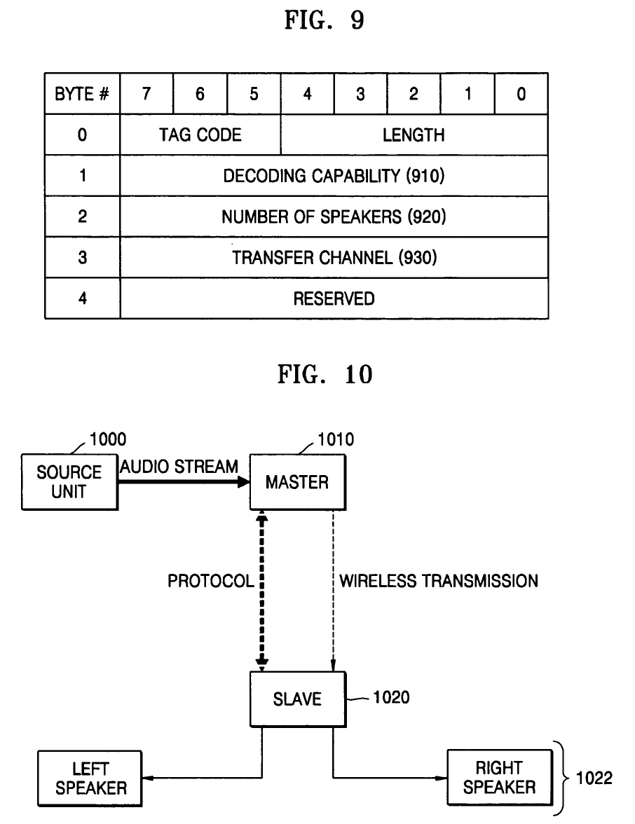

FIG. 9 is a diagram of a message based on a protocol according to an embodiment of the present invention. Referring to FIG. 9, the message based on the protocol for transmitting/receiving information on an audio stream necessary to a slave 620 between a master 610 and the slave 620 is illustrated. When the slave 620 has a state change (i.e., when the slave 620 is turned on, or when speakers or other devices are additionally connected to or disconnected from the slave 620), the slave 620 informs the master 610 that a configuration of the slave 620 is changed using the message based on the protocol. When the master 610 receives the message informing that the configuration of the slave 620 is changed from the slave 620, the master 610 reads the configuration state of the slave 620 using the message based on the protocol and determines a feature of the audio stream data necessary to the slave 620.

In detail, according to the embodiment of the message based on the protocol, the message includes a “tag code” field, a “length” field, a “decoding capability 910” field, a “number of speakers 920” field, and a “transfer channel 930” field. However, it is understood that other fields can be used, such as fields to indicate security protocols to ensure secure transmission and fields to identify the slave/master. It is further understood that fewer fields can be used and/or that the information can be disposed at other byte positions within the fields.

The “tag code” is in bits 5-7 of byte # 0 and indicates a kind of data to be transmitted. That is, it indicates that the message contains information on an audio stream necessary to the slave. However, it is understood that if non-audio or if a mixture of audio and other data (i.e., text, pictures, software, etc.) are used, the tag code would so indicate.

The “length” is in bits 0-4 of byte # 0 and indicates the number of bytes of the data to be transmitted.

The “decoding capability 910” is in byte # 1 and indicates encoding methods by which the slave 620 can perform decoding. For example, encoding methods such as a DTS 5.1 channel and an AC-3 7.1 channel can be included. However, it is understood that other types of decoding can be used.

The “number of speakers 920” is in byte # 2 and indicates information on external devices used by the slave 620 (i.e., the number of external devices such as speakers connected to the slave 620).

The “transfer channel 930” is in byte # 3 and indicates audio channel data supported by the slave 620. For example, a left rear speaker channel and a right rear speaker channel can be included.

As shown, byte # 4 is reserved.

By the master 610 extracting only data necessary to the slave 620 and wirelessly transmitting the extracted data using the message based on the protocol, a multi-channel audio stream can be smoothly reproduced even in a wireless environment with a limited bandwidth.

FIG. 10 is a block diagram of an audio system according to another embodiment of the present invention. Referring to FIG. 10, a master 1010 receives an audio stream from a source unit 1000 and wirelessly transmits the audio stream, which is reduced using the protocol, to only a pair of left and right speakers 1022 using a slave 1020. An example of such speakers 1022 includes, but is not limited to, wireless headphones that receive only a stereo signal. Other examples could be for use in additionally wirelessly transmitting to the all or combinations of the front speakers, sub-woofer, center speaker 612 shown in FIG. 6, or where no rear speakers are used such as in 2.1 virtual surround sound systems. Further examples could be for uses with speakers disposed outside of a same room, such as speakers used outside of the house and/or in a kitchen.

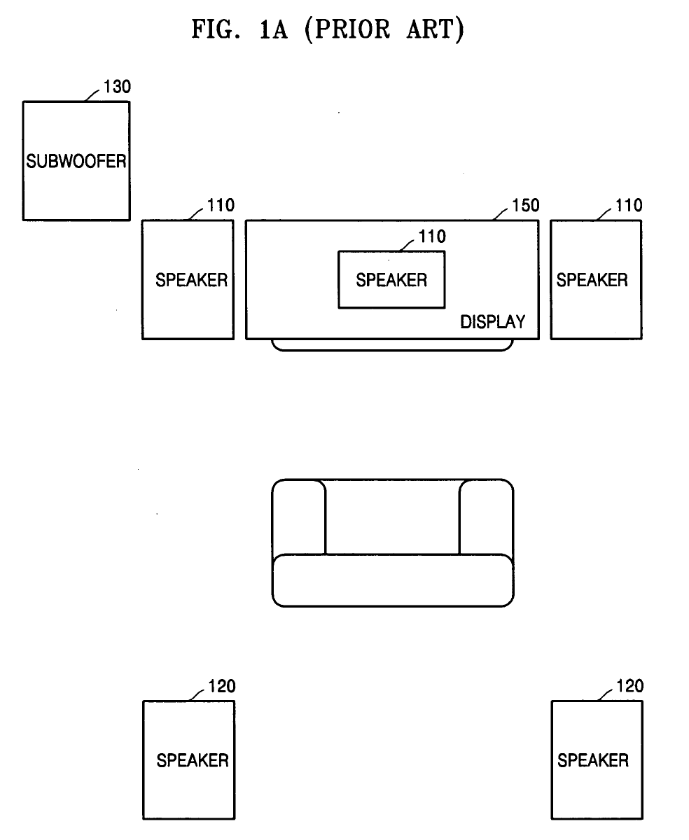

It is further understood that wireless transmission can be achieved using IEEE 802.11 based transmissions, Bluetooth, ultra-wideband technology (UWB), and other techniques by which communications are performed without a hardwired connection. [0047]. Further, while shown as separate, it is understood that the slave can be integrated directly into one or both of the speakers 622, 1022 so as to further reduce the amount of wiring being performed. It is further understood that additional information can be included with the transmission, such as text, to indicate artist or title information, video, and/or images to be displayed on other devices having displays connected to the slave. Moreover, while described in terms of use in a home theater, it is understood that the source need not also provide a video signal, such as occurs with DVD-Audio. It is understood that the embodiments of the invention can be used in a home theater such as that shown in FIGS. 1A and 1 B. Moreover, it is understood that the master/slave relationship can be reversed and/or can operate on a peer relationship.

Also, while not required, it is understood that the compatibility information transmitted using a protocol, such as the protocol shown in FIG. 9, can be stored on a computer readable medium, or in any volatile or non-volatile memory of the slave and/or master. Similarly, the functionality related to the use of the compatibility information performed by the slave and master, such as by the parser 730, can be implemented using computer software encoded on a computer readable medium to be implemented by a general or special purpose computer.

Additionally, where the compatibility information is not transmitted by the slave so as to automatically indicate the audio stream to be extracted or where a user wishes to temporarily override the compatibility information otherwise being indicated using the transmitted protocol (such as where a speaker is to be temporarily muted), it is understood that the compatibility information can be input directly through the source and/or master using a keyboard, remote control, or other such input device.

Moreover, examples of source units 600, 1000 include, but are not limited to, audio and/or video receivers, digital video recorders, computers, digital audio players, recording and/or reproducing apparatuses including optical media apparatuses, and any other portable or non-portable device which stores and/or reproduces audio data and/or other data.

As described above, according to embodiments of the present invention, by extracting only data necessary to a slave and transmitting the data, a multi-channel audio system using a wireless network in which data is transmitted by saving a data bandwidth in a wireless communication environment in which a bandwidth of transmitted/received data is limited.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. A multi-channel audio system comprising:
a master which decodes an input multi-channel audio stream, outputs the decoded multi-channel audio stream, extracts a predetermined audio stream from the output multi-channel audio stream based upon received compatibility information, and wirelessly transmits the extracted audio stream; and
a slave which transmits to the master the compatibility information indicating a type of audio stream supported by the slave among the multi-channel audio stream decoded by the master, wirelessly receives the extracted audio stream from the master based upon the transmitted compatibility information, decodes the received audio stream, and outputs the decoded audio stream.

2. The system of claim 1, wherein the master comprises:
an audio decoder which decodes the input multi-channel audio stream;
an audio output module which outputs the decoded multi-channel audio stream;
a stream parser which extracts the predetermined audio stream supported by the slave by parsing the input multi-channel audio stream; and
a wireless transmitter which wirelessly transmits the extracted audio stream, receives the compatibility information on the audio stream supported by the slave using a message according to a predetermined protocol, and controls the stream parser to extract a relevant portion of the audio stream from the input multi-channel audio stream according to the message.

3. The system of claim 1, wherein the slave comprises:
a wireless receiver which transmits the compatibility information on the type of audio stream supported by the slave to the master using a message according to a predetermined protocol and wirelessly receives the audio stream supported by the slave from the master as indicated by the transmitted compatibility information;
an audio decoder which decodes the received audio stream; and an audio output module which outputs the decoded audio stream.

4. The system of claim 2, wherein ,the message according to the predetermined protocol includes information indicating a decoding capability of the slave, information on external devices used by the slave, information on channels supported by the slave, or combinations thereof.

5. The system of claim 4, wherein the information indicating decoding capability of the slave individually indicates and distinguishes between an encoding scheme using a DTS 5.1 channel or an AC-3 7.1 channel that can be decoded by the slave.

6. The system of claim 4, wherein the information on external devices used by the slave indicates a number of external devices connected to the slave.

7. The system of claim 4, wherein the information on channels supported by the slave indicates data on a left rear speaker channel and/or a right rear speaker channel that are received by and output from the slave.

8. The system of claim 2, wherein:
the input multi-channel audio stream includes a core data portion and an extended data portion other than the core data portion, and the stream parser extracts only the core data portion except the extended data portion among the input multi-channel audio stream.

9. The system of claim 8, wherein the stream parser extracts only data corresponding to channels supported by the slave among the core data portion.

10. A home theater system comprising the multi-channel audio system of claim 1 and an image device to display received image and/or video data.

11. The system of claim 3, wherein the message according to the predetermined protocol information indicating a decoding capability of the slave, information on external devices used by the slave, information on channels supported by the slave, or combinations thereof.

12. The system of claim 11, wherein the information indicating decoding capability of the slave individually indicates and distinguishes between an encoding scheme using a DTS 5.1 channel or an AC-3 7.1 channel that can be decoded by the slave.

13. The system of claim 11, wherein the information on external devices used by the slave indicates a number of external devices connected to the slave.

14. The system of claim 11, wherein the information on channels supported by the slave indicates data on a left rear speaker channel and/or a right rear speaker channel that are received by and output from the slave.

15. The system of claim 11, wherein the information on external devices used by the slave indicates a number of speakers connected to the slave.

16. The system of claim 4, wherein the information on external devices used by the slave indicates a number of speakers connected to the slave.

17. The system of claim 1, wherein the compatibility information transmitted by the slave indicates that less than all of the decoded multi-channel audio stream are to be wirelessly transmitted to the slave.

18. The system of claim 1, wherein:
the decoded multi-channel audio stream includes first audio data encoded in a first format and second audio data encoded in a second format other than the first format, and the compatibility information transmitted by the slave indicates that the first format is supported such that the master wirelessly transmits the first audio data encoded in the first format without transmitting the second audio data encQded in the second format.

19. A multi-channel audio system comprising:
a transmitter which selectively parses an input multi-channel audio stream to extract an audio stream based upon input compatibility information, and wirelessly transmits the extracted audio stream; and
a receiver which is compatible with the extracted audio stream as indicated in the compatibility information, wirelessly receives the extracted audio stream from the transmitter based upon the input compatibility information, and outputs the received audio stream.

20. The multi-channel audio system of claim 19, wherein the receiver communicates the compatibility information to the transmitter prior to the transmitter selectively parsing the input multi-channel audio stream, and the transmitter parses the input multi-channel audio stream according to the communication compatibility information.

21. The multi-channel audio system of claim 19, wherein the compatibility information comprises one or more fields which indicate and differentiate between different decoding capabilities of the receiver, different devices connected to the receiver, different channels supported by the receiver, different numbers of devices connected to the receiver, or combinations thereof.

22. The multi-channel audio system of claim 19, wherein the compatibility information indicates and differentiates between a first encoding scheme and a second encoding scheme, and the transmitter parses and transmits only data in the input multi-channel audio stream which corresponds to the indicated one of the first and second encoding schemes.

23. The multi-channel audio system of claim 19, wherein:
the compatibility information indicates to the transmitter a type of data to be used by a device connected to the receiver, and information on a number of devices connected to the receiver, and the transmitter parses and transmits only data in the input multi-channel audio stream which corresponds to the indicated type of date and number of devices.

24. The multi-channel audio system of claim 19, wherein the compatibility information indicates to the transmitter that less than all of the input multi-channel audio stream are to be wirelessly transmitted to the receiver, and the transmitter parses and transmits only data in the input multi-channel audio stream which corresponds to the indicated amount of data.

25. The multi-channel audio system of claim 19, wherein:
input multi-channel audio stream includes first audio data encoded in a first format and second audio data encoded in a second format other than the first format, and the compatibility information indicates that the first format is supported such that the transmitter wirelessly transmits the first audio data encoded in the first format without transmitting the second audio data encoded in the second format.

26. The multi-channel audio system of claim 19, wherein the transmitter receives the compatibility information after a change in state of the receiver, and changes an amount of the extracted audio stream according to the change in the state.

27. A transmitter device for use with a multi-channel audio system having a wireless receiving device, the transmitter device comprising:
a parsing unit which selectively parses an input multi-channel audio stream to extract an audio stream based upon input compatibility information; and
a transmitter which wirelessly transmits the extracted audio stream to the wireless receiving device, the wireless receiving device being compatible with the extracted audio stream as indicated in the compatibility information.

28. The transmitter device of claim 27, further comprising a decoder which decodes received multi-channel audio stream to provide the input multi-channel audio stream to the parsing unit.

29. The transmitter device of claim 27, wherein the transmitter receives the compatibility information after a change in state of the wireless receiving device, and the parsing unit changes an amount of the extracted audio stream, according to the change in the state.

30. A receiver device for use with a multi-channel audio system having a wireless transmitter device, the receiver device comprising:
a transmitter which wirelessly transmits to the wireless transmitter device compatibility information indicating a type of audio stream to be transmitted, and wirelessly receives an extracted audio stream from the transmitter device which was extracted based upon the transmitted compatibility information; and
a decoder which decodes the received audio stream for use with a device connected to the transmitter.

31. The receiver device of claim 30, wherein the transmitter transmits the compatibility information after a change in state of the device connected to the transmitter so as to change an amount of the extracted audio stream according to the change in the state.

32. A memory encoded with data used by a transmitting device of a wireless multi-channel audio system to determine an audio capability of a wireless receiving device, the memory comprising:
a type code individually indicating and distinguishing between types of data, the type code being used by the transmitting device to identify a type of data that is compatible with the wireless receiving device;
decoding capability information individually indicating and distinguishing between types of decoding techniques, the decoding capability information being used by the transmitting device to determine a type of decoding that is compatible with the wireless receiving device;
number of devices information individually indicating and distinguishing between to the transmitting device a number of channels, the number of devices information being used by the transmitting device to determine a number of channels used by the wireless receiving device and which are to be parsed from an input multi-channel signal; and transfer channel information individually indicating and distinguishing between which of the channels are used by devices connected to the wireless receiving device, the transfer channel information being used by the transmitting device to determine which of the channels are to be parsed and transmitted to the wireless receiving device.
